(19) United States
(12) Patent Application Publication
(10) Pub. No.: US 2011/0266999 A1
(43) Pub. Date: Nov. 3, 2011

(54) Remote Control For Fluid Dispensing Device with a Rechargeable Power Source

(76) Inventors: Ofer Yodfat, Modi'in (IL); Avihoo P. Keret, Kfar Vradim (IL); Danna Perlman, Haifa (IL); Tsabar Mor, Naharyaa (IL); Illai Gescheit, Tel Aviv (IL)

(21) Appl. No.: 13/061,876

(22) PCT Filed: Sep. 1, 2009
(86) PCT No.: PCT/IL09/00840

§ 371 Date: Jun. 1, 2011

Related U.S. Application Data
(60) Provisional application No. 61/093,583, filed on Sep. 2, 2008.

(51) Int. Cl. H02J 7/00

(52) U.S. Cl. 320/107

(57) ABSTRACT

Disclosed are systems methods and devices, including a system that includes a dispensing unit to dispense therapeutic fluid and a remote control (900) to control, at least in part, operation of the dispensing unit. The remote control (900) includes a rechargeable power source to power at least part of the remote control, at least one connector (86) to electrically couple the remote control (900) to at least one other power source located externally to the remote control, and a controller to cause the remote control to receive power from one or more of the rechargeable power source and/or the other power source. Also disclosed is a power device (400) for powering a remote control of a dispensing system. The power device includes at least one connector (409) to electrically couple the remote control (900) to at least one power source and a portable housing (401) including a chamber to receive the at least one power source.

### CROSS-REFERENCE TO RELATED APPLICATIONS

This application claims priority to provisional U.S. application Ser. No. 61/093,583, entitled “Remote Control for Fluid Dispensing Device with Rechargeable Power Source,” filed Sep. 2, 2008, the content of which is hereby incorporated by reference in its entirety.

### FIELD

Embodiments of the present disclosure relate generally to a system, a device and a method for sustained medical infusion of fluids and/or continuous monitoring of body analyte. More particularly, the present disclosure is related to a device that comprises a portable dispenser and/or an analyte sensor controlled by a remote control with a rechargeable energy storage cell.

### BACKGROUND

### Diabetes and Insulin Pumps

Medical treatment of several illnesses requires continuous or periodic drug infusion into various body compartments, such as subcutaneous and intra-venous injections. Diabetes mellitus (DM) patients, for example, require the administration of varying amounts of insulin throughout the day to control their blood glucose levels. In recent years, ambulatory portable insulin infusion pumps have emerged as a superior alternative to multiple daily syringe injections of insulin, initially for Type 1 diabetes patients (Diabetes Medicine 2006; 23(2):141-7) and subsequently for Type 2 (Diabetes Metab 2007 Apr. 30, Diabetes Obes Metab 2007 Jun. 26). These pumps, which deliver insulin at a continuous and/or periodical basal rate as well as in bolus volumes, were developed to liberate patients from repeated self-administered injections, and to enable them to maintain a near-normal daily routine. Both basal and bolus volumes should be delivered in precise doses, according to individual prescription, because an overdose or under-dose of insulin could be fatal.

Most diabetic patients currently measure their own blood glucose several times during the day by obtaining finger-prick capillary samples and applying the blood to a reagent strip for analysis in a portable meter. Whilst blood glucose self-monitoring has had a major impact on improving diabetes care in the last few decades, the disadvantages of this technology are substantial, leading, as a result, to non-compliance. For example, blood sampling is associated with the discomfort of multiple skin pricking, the inability to perform testing when the subject is sleeping or otherwise occupied (e.g., while driving a motor vehicle), etc. Conventional blood testing also relies on performance of intermittent tests, and as a result a patient may miss episodes of hyper and hypoglycemia. The optimal glucose monitoring technology should therefore employ automatic and continuous and/or frequent testing.

Currently, there are three techniques for continuously monitoring of glucose in the subcutaneous interstitial fluid (ISF):
1. The first technique is based on use of glucose oxidase based sensors as described, for example, in U.S. Pat. Nos. 6,360,888 to Collin and 6,892,085 to McIvor (corresponding to CGMS, Guardian™ and CGMS Gold), and in 6,881,551 to Heller, (corresponding to Navigator™), the contents of all of which are hereby incorporated by reference in their entireties. These sensors include a subcutaneously implantable, needle-type amperometric enzyme electrode, coupled with a portable logger.
2. The second technique is based on use of reverse iontophoresis based sensors as detailed, for example, in U.S. Pat. No. 6,391,643 to Chen, (corresponding to GlucoWatch™), the content of which is hereby incorporated by reference in its entirety. A small current passed between two electrodes located on the skin surface draws ions and (through an electro-endosmosis process) glucose-containing interstitial fluid to the surface and into hydrogel pads incorporating a glucose oxidase biosensor (see also JAMA 1999; 282: 1839-1844, the content of which is hereby incorporated by reference in its entirety).
3. A third commercial technology in current clinical use is based on microdialysis procedures (as described, for example, in Diab Care 2002; 25: 347-352), and as further detailed in U.S. Pat. No. 6,091,976 to Pfeiffer, the contents of all of which are hereby incorporated by reference in their entireties. Another commercially available device is Menarini Diagnostics' GlucoDay™ device. In the latter device, a fine, hollow dialysis fiber is implanted in the subcutaneous tissue and perfused with isotonic fluid. Glucose from the tissue diffuses into the fiber and is pumped outside the body for measurement by a glucose oxidase-based electrochemical sensor. Initial reports (as described, for example, in Diab Care 2002; 25: 347-352) show good agreement between sensor and blood glucose readings, and good stability with a one-point calibration over one day.

### Portable Insulin Pumps

The first generation of portable insulin pumps included “pager like” devices, each having a reservoir contained within a housing. A long tube delivered insulin from the pump attached to a patient's belt to a remote insertion site. The reservoir, delivery tube and the hypodermic cannula were altogether referred to as an “infusion set”. The recommendation for infusion set replacement is every 2-3 days to avoid local infection at the cannula insertion site. Such devices are described, for example, in U.S. Pat. Nos. 3,631,847, 3,771,694, 4,498,843, 4,657,486 and 4,544,369, the contents of all of which are hereby incorporated by reference in their entireties. These devices represent a significant improvement over having to perform multiple daily injections, but suffer from some drawbacks, amongst which are the devices' relatively large sizes and weight, as well as their relatively long tubing. One of the main reason for the large weight and volume of these devices is the large sized batteries (e.g., of AA or AAA-type batteries) that they require for meeting the high energy demand of the motor, screen, alarms, and other power consuming components/unit of the devices.

These uncomfortable bulky devices with long tubes are disfavored and often rejected by diabetic insulin users because they interfere with their regular activities, e.g., sport activities such as swimming. To avoid the tubing limitations, a new concept for a second generation of pumping devices was proposed. The new concept was predicated on the use of a remote controlled skin adherable device with a housing having a bottom surface adapted for contact with the patient's skin, with a reservoir contained within the housing, and with an injection needle adapted for fluid communication with the reservoir. These skin securable (e.g., adherable) devices are configured to be replaced every 2-3 days similarly to the currently available pump infusion sets. However, most patients prefer to extend this period until the reservoir is emptied. This therapeutic infusion approach is described, for example, in U.S. Pat. Nos. 4,498,843, 5,957,895, 6,589,229, 6,740,059, 6,723,072 and 6,485,461, the contents of all of which are hereby incorporated by reference in their entireties. Second generation skin securable devices have some drawbacks:
The entire device, including all the expensive components (electronics, driving mechanism), generally has to be disposed of approximately every 3 days.
The remote controlled skin adherable device is heavy and bulky, which is a major limitation for maintaining daily activity. The main reason for the large size and heavy weight is the size and number of batteries that supply energy to power the motor, alarms, and the communication link that needs to be maintained between the skin securable device and the remote control.

Third generation (3^{rd} gen.) skin securable devices were developed to avoid the cost constraints (resulting, for example, from having to discard an entire unit) and to extend patient customization. An example of such a device was described in co-owned patent applications U.S. Ser. No. 11/397,115 (U.S. publication no. 2007/0106218) and PCT/IL06/001276 (international publication no. WO2007/052277), the contents of which are hereby incorporated by reference in their entireties. A third generation device includes a remote control and a skin securable patch unit that comprises two parts:
A reusable part—this part may contain the metering portion, electronics, and other relatively expensive components such as sensors for occlusion detection, reservoir volume and motor operation.
A disposable part—this part contains the reservoir and, in some embodiments, the power source (e.g., one or more batteries). A tube delivers the fluid from the reservoir to an outlet port that includes a connecting lumen.

The above concept provides a cost-effective skin securable infusion device and enables diverse usages such as various reservoir sizes, various needle and cannula types, etc.

### Remote Control for Dispensing Unit

A remote control enables the user to program the drug administration operations and to control the infusion pump without physically manipulating the pump.

Embodiments of a method for diabetes therapy include continuously infusing insulin to the user's body in varying rates, because the need for insulin during the day is subject to great fluctuations. Insulin dosage may be determined, for example, by carbohydrate intake and physical condition. It has been shown that—when using self-regulating infusion devices that do not employ glucose sensors for automatic control of insulin infusion—the delivery of insulin should be adjusted according to a daily profile that should be individually tailored and programmed for the user. Both 2^{nd} and 3^{rd} generation skin securable (e.g., adherable) infusion pumps may be operated by a remote control because they are usually secured to specific skin sites below the clothing.

The remote control (also referred to as “RC”) typically includes:
A control interface that includes, for example, control buttons, a keypad, a touch screen, etc., enabling a user to program and activate the RC and/or the infusion pump.
A notification unit (also referred to as a notifier or an indicator), such as display, buzzer, speaker etc., to provide messages and notify the user about, for example, the condition of the device, the amount of fluid in the reservoir, the flow rate of the therapeutic fluid being delivered, etc.
A processor to control the various functions of the remote control.
An RF communication module to enable communication between the remote control and the infusion pump.
An energy supply—such a supply may include, in some embodiments, one or more batteries that provide energy to the remote control's electrical components.

A remote control, such as the one described above, is disclosed, for example, in U.S. Pat. No. 4,559,037, the content of which is hereby incorporated by reference in its entirety. Further embodiments of a remote control for infusion pump are described, for example, in U.S. Pat. No. 6,768,425, the content of which is hereby incorporated by reference in its entirety. The latter patent describes a multifunctional remote control which can be used to control an infusion pump, a PDA (personal digital assistance) and/or a cellular phone. The remote control is powered by two separate power sources, one for multifunctional usage and the other for backup. When power is provided from the backup battery, the RC sole operation is to control the infusion pump while other functions are disabled. Other features of the RC include: 1) both power sources are contained within the RC, making it bulky and heavy, 2) the RC is powered by a backup power source whose operation is restricted for specific, pre-defined and limited number of functions.

### Battery Types

Disposable batteries (i.e., non-rechargeable batteries, also referred to as “primary batteries”) are among the most expensive energy sources, and their manufacturing consumes many valuable resources and requires the use of chemicals that are hazardous to humans and the environment. Thus, these batteries require special treatment or recycling before they can be disposed of. Rechargeable batteries are more cost effective and environmentally friendly. However, these batteries have to be periodically recharged. Furthermore, a rechargeable battery cannot interchangeably be used with a disposable battery because it can damage the device or even cause an explosion. Generally, remote controls for infusion pump are currently powered by primary batteries because of their easy availability and safety.

Rechargeable batteries can be used as power supplies for portable electronic devices, such as a dispensing unit's remote control, as long as back up batteries are available. Some portable electronic devices, such as digital cameras, video recorders, portable audio players and the like, can be powered by externally connected auxiliary batteries. Such electronic devices are described, for example, in U.S. Pat. No. 6,203,363, the content of which is hereby incorporated by reference in its entirety. This patent describes an exterior connection of the electronic device to an external battery casing. The electrical device casing includes moveable connectors that are protected within the casing when not connected to the battery casing, and are at the casing exterior when connected to the battery casing. The battery casing may be detached from the device by “rotating and sliding movement”. These types of connections are relatively expensive and bulky.

Other examples are described in U.S. Pat. No. 7,136,682, and U.S. Pat. No. 5,610,496, the contents of which are hereby incorporated by reference in their entireties. These patents describe an electrical device with an auxiliary battery, in which the auxiliary battery casing includes a sensing and controlling mechanisms for activating and deactivating the auxiliary battery. The sensing and controlling mechanisms are configured for a specific type(s) of battery, thus limiting the usage and reducing the availability of backup batteries. Furthermore, the casings have higher costs because they include both sensing and controlling mechanisms (e.g., power gauge).

### SUMMARY

Thus, in some embodiments, a remote control (also referred to as a remote control unit) for use with an infusion (dispensing) device that is powered by a rechargeable battery and can also be powered by a primary power source (non-rechargeable) is provided.

In some embodiments, a remote control for continuous and/or a periodic sensing operations that is powered by a rechargeable battery and can also be powered by a primary power source (non-rechargeable) is provided.

In some embodiments, a remote control for infusion device and a continuous sensor that can include a blood glucose monitor powered by a rechargeable battery, and which may also be powered by primary power source (e.g., non-rechargeable battery) is provided.

In some embodiments, a remote control for an infusion device that is powered by a rechargeable battery and that can also be powered by different types of non rechargeable batteries (AA, AAA and the like) is provided.

In some embodiments, a remote control for an infusion device that is powered by a rechargeable battery that can be connected to an external primary (e.g., non rechargeable) power source is provided.

In some embodiments, a remote control for an infusion device that is powered by a rechargeable battery and which can also be powered by a primary (e.g., non rechargeable) power source is provided.

In some embodiments, a dispensing system that includes a dispensing unit to dispense therapeutic fluid and a remote control to control, at least in part, the dispensing unit, that is powered by a rechargeable battery and may also be powered by a primary (e.g., non rechargeable) power source is provided.

In some embodiments, a therapeutic fluid dispensing system is provided. The system includes a dispensing unit to dispense therapeutic fluid and a remote control to control, at least in part, operation of the dispensing unit. The remote control includes a rechargeable power source to power at least part of the remote control, at least one connector to electrically couple the remote control to at least one other power source located externally to the remote control, and a controller to cause the remote control to receive power from one or more of the rechargeable power source and/or the at least one other power source.

Embodiments of the system may include one or more of the following features.

The controller may be configured to cause the remote control to receive power, based on at least one measured characteristic of the rechargeable source, from one or more of, for example, the rechargeable power source and/or the at least one other power source.

The at least one measured characteristic may include at least one of, for example, charge level of the rechargeable source, voltage level of the rechargeable source and/or temperature of the rechargeable source.

The controller may be configured to cause the remote control to receive power from the rechargeable source when a determined charge level of the rechargeable source exceeds a pre-determined threshold representative of a charge level sufficient to continue power delivery from the rechargeable source for a predetermined period of time.

The controller may be configured to cause the remote control to receive power from one or more auxiliary batteries electrically connected to the remote control when a determined charge level of the rechargeable source is below a pre-determined threshold representative of an insufficient charge level to continue power delivery from the rechargeable source for a predetermined period of time.

The rechargeable power source may include one or more rechargeable batteries.

The at least one connector may include at least one connector to electrically couple to one or more non-rechargeable electrochemical cells.

The at least one connector may include at least one connector to electrically couple to a high power source for providing power to cause one or more of, for example, charge of the rechargeable power source and power at least part of the remote control.

The at least one connector may include a USB connector.

The remote control may further include a chamber to receive one or more auxiliary non-rechargeable batteries, the one or more auxiliary non-rechargeable batteries being electrically coupled to the at least one connector. The chamber may be detachably connectable to the remote control.

The at least one connector may be adapted to electrically couple to a plurality of auxiliary power sources.

The at least one connector may include a first connector to electrically couple to a first auxiliary power source and a second connector to electrically couple to a second auxiliary power source.

The remote control may further include a casing to house the remote control that includes a chamber to house at least one auxiliary power source and the at least one connector to electrically connect between the remote control and the at least one auxiliary power source.

The remote control may further include a notifier to provide output information to a user regarding one or more of, for example, charge level in the rechargeable power source, performance of a recharging operation of the rechargeable power source, electrical connectivity of power sources to the remote control and/or parameters related to one or more of the rechargeable power source and the at least one other power source.

The remote control may further include one or more fuel gauges to monitor the rechargeable power source and an auxiliary power source.

The controller may be configured to determine, based on at least one measured characteristic, a charge level of at least the rechargeable source and/or the at least one other power source.

The remote control may further include a memory to store data related to operation of the dispensing unit and at least one measured characteristic of the rechargeable source. The remote control may further include a sensor to measure a patient's analytes concentration levels. The analytes concentration levels may include a glucose concentration level.

In some embodiments, a system is provided. The system includes a medical device to perform at least one medical operation, and a remote control to control, at least in part, operation of the medical device. The remote control includes a rechargeable power source to power at least part of the remote control, at least one connector to electrically couple the remote control to at least one other power source located externally to the remote control, and a controller to cause the remote control to receive power from one or more of the rechargeable power source and/or the at least one other power source.

Embodiments of the system may include any of the above-described features of the first system, as well as one or more of any of the following features.

The medical device may include one or more of, for example, a therapeutic fluid dispensing device and/or a sensor to measure a patient's analytes concentration levels. The sensor may include one or more of, for example, a glucometer and a continuous blood glucose monitor.

In some embodiments, a method is provided of powering a remote control of a dispensing system which includes a dispensing unit to dispense therapeutic fluid and the remote control to control, at least in part, operation of the dispensing unit. The method includes electrically connecting the remote control to a rechargeable power source, electrically connecting the remote control to at least one other power source located externally to the remote control, and directing power to the remote control from one or more of the rechargeable power source and/or the at least one other power source.

Embodiments of the method may include any of the above-described features of the system, as well as one or more of any of the following features.

The method may further include measuring at least one characteristic of the rechargeable power source. Directing power to the remote control may be based, at least in part, on the at least one measured characteristic of the rechargeable source.

Measuring the at least one characteristic of the rechargeable power sources may include measuring one or more of, for example, charge level of the rechargeable power source, voltage level of the rechargeable power source and/or temperature of the rechargeable power source.

Directing power may include directing power from the rechargeable source when a determined charge level of the rechargeable power source exceeds a pre-determined threshold representative of a charge level sufficient to continue power delivery from the rechargeable power source for a predetermined period of time.

The at least one other power source may include one or more auxiliary batteries electrically connectable to the remote control when a determined charge level of the rechargeable source is below a pre-determined threshold representative of an insufficient charge level to continue power delivery from the rechargeable source for a predetermined period of time.

Electrically connecting the remote control to the at least one other power source may include electrically connecting the remote control to a chamber structured to receive one or more auxiliary non-rechargeable batteries. The chamber may be detachably connectable to the remote control.

The at least one other power source may include a high power source configured to provide power to cause one or more of, for example, charge the rechargeable power source and/or power at least part of the remote control.

In some embodiments, a remote control to control, at least in part, operation of a dispensing unit to dispense therapeutic fluid is provided. The remote control includes a communication module to communicate with the dispensing unit, a rechargeable power source to power at least part of the remote control, at least one connector to electrically couple the remote control to at least one other power source located externally to the remote control, and a controller to cause power to be received from one or more of the rechargeable power source and the at least one other power source.

Embodiments of the remote control may include any of the above-described features of the system and method, as well as one or more of any of the following features.

The controller may be configured to cause the power to be received by the remote control based on at least one measured characteristic of one or more of, for example, the rechargeable power source and/or the at least one other power source.

The measured characteristic may include one or more of, for example, charge level of the rechargeable source, voltage level of the rechargeable source and/or temperature of the rechargeable source.

The controller may be configured to cause the power to be received from the rechargeable source when a determined charge level of the rechargeable source exceeds a pre-determined threshold representative of a charge level sufficient to continue power delivery from the rechargeable source for a predetermined period of time.

The at least one other power source may include one or more auxiliary batteries electrically connectable to the remote controller when a determined charge level of the rechargeable source is below a pre-determined threshold representative of an insufficient charge level to continue power delivery from the rechargeable source for a predetermined period of time.

The rechargeable power source may include one or more rechargeable batteries.

The at least one other power source may include an external high power source to provide power to cause one or more of, for example, charge the rechargeable power source and/or power at least part of the remote control.

The at least one other power source may include a chamber to receive one or more auxiliary non-rechargeable batteries, the one or more auxiliary non-rechargeable batteries being electrically coupled to the at least one connector. The chamber may be detachably connectable to the remote control.

The remote control may further include a notifier to provide information to a user regarding one or more of, for example, charge level in the rechargeable power source, performance of a recharging operation of the rechargeable power source, electrical connectivity of power sources to the remote control and/or parameters related to one or more of the rechargeable power source and the at least one other power source.

In some embodiments, a power device is provided for powering a remote control of a dispensing system that includes a dispensing unit to dispense therapeutic fluid and the remote control to control, at least in part, operation of the dispensing unit. The power device includes at least one connector to electrically couple the remote control to at least one power source and a portable housing including a chamber to receive the at least one power source.

Embodiments of the power device may include any of the above-described features of the system, method and remote control, as well as one or more of any of the following features.

The portable housing may be detachably connectable to the remote control.

The at least one connector may include a USB connector.

The power device may further include a fastener to anchor the power device to the remote control.

Power may be directed to the remote control from the at least one power source based on at least one measured characteristic of a rechargeable source of the remote control.

Details of one or more implementations are set forth in the accompanying drawings and in the description below. Further features, embodiments, aspects, and advantages will become apparent from the description, the drawings, and the claims.

### BRIEF DESCRIPTION OF THE DRAWINGS

Some of the embodiments of the present disclosure are described with reference to the accompanying drawings. In the drawings, like reference numbers indicate identical or functionally similar elements.

FIG. 1 is a schematic diagram of a fluid delivery device that includes a dispensing unit and a remote control unit.

FIGS. 2a-2c are schematic diagrams of a fluid delivery device comprising a dispensing unit that can be composed of a single part (FIG. 2a) or two-parts (FIG. 2b), and may include a cradle unit and a cannula cartridge unit (FIG. 2c).

FIGS. 3a-3d are views and diagrams of a two-part fluid dispensing units securable to skin of a patient.

FIGS. 4a-4c are views and diagrams of a skin adherable cradle unit and a dispensing unit that is connected to the cradle unit.

FIGS. 5a-5b illustrate a dispensing unit and the operation of the dispensing unit via buttons located on the dispensing unit.

FIGS. 6a-6d are diagrams and views of a remote control of a fluid delivery device used to control, operate and program a dispensing unit, and which may include a blood glucose meter (FIGS. 6b-6d) and a chamber for an auxiliary power source (FIGS. 6c-6d).

FIGS. 7a-7b are diagrams and views illustrating a fluid delivery device that includes a dispensing unit and a remote control with a blood glucose meter and a chamber for an auxiliary battery (FIG. 7a) or for two batteries (FIG. 7b).

FIGS. 8a-8c are diagrams and views of remote control units, for a fluid delivery device, with rechargeable batteries that can be installed within the remote control (FIG. 8a) or can be detachably connectable to the remote control (FIGS. 8b-8c).

FIGS. 9a-9b are diagrams and views illustrating remote control units, for a fluid delivery device, having a rechargeable battery and a chamber for an auxiliary battery (FIG. 9a) or for two auxiliary batteries (FIG. 9b).

FIGS. 10a-10b are diagrams and views that illustrate a remote control with a connector to connect an external power source to charge the rechargeable battery.

FIG. 11 is a perspective view of a remote control and a detachably connectable chamber to house an auxiliary battery.

FIGS. 12a-12c are diagrams and views of embodiments of a detachably connectable chamber for auxiliary batteries.

FIG. 13 is a diagram of a housing of a remote control and auxiliary batteries.

FIG. 14 is a flowchart of a procedure to provide power to the remote control and to charge a rechargeable battery used with the remote control.

FIG. 15 is a diagram depicting the electronic components/units of a remote control with a rechargeable battery.

FIG. 16 is a block diagram depicting an implementation of a circuit configuration to charge a rechargeable battery and provide power to a remote control.

FIG. 17 is a graph showing the charge levels of a rechargeable battery during operation of a remote control employing the rechargeable battery.

FIGS. 18a-18b are views and diagrams illustrating remote controls with displays to indicate batteries' state of charge levels.

### DETAILED DESCRIPTION

The present disclosure generally relates to a remote control (also referred to as a remote control unit and/or a remote controller) of therapeutic fluid(s) infusion pump, and in particular, to a remote control of portable therapeutic fluid dispensing/delivery/infusion devices (the terms dispensing, delivery and infusion being used interchangeably), with a rechargeable power source. In some embodiments, a fluid delivery device is disclosed that includes a fluid dispensing unit which may include a reusable part and a disposable part, and may include a remote control. The reusable part may contain the relatively expensive components, such as the electronics, at least a portion of driving mechanisms (and in some embodiments, all the components of driving mechanisms), sensors, motors and various other components. The disposable part may include a reservoir to contain therapeutic fluid (e.g., insulin), a connecting tube for delivery of the therapeutic fluid, a piston/plunger (the terms piston and plunger may be used interchangeably) for punting fluid from the reservoir to the body, and a power supply for providing power to at least one of the reusable and/or disposable parts of the fluid delivery device. The disposable part can also be configured to include a portion of the driving mechanism, so that the driving mechanism would be shared, under those circumstances, by both parts (the disposable and the reusable).

In some embodiments, a power supply may be located in the reusable part. In some embodiments, a power supply can be located in both parts. An example of a fluid dispensing unit composed of two parts is described in co-pending/co-owned U.S. patent application Ser. No. 11/397,115 (U.S. publication no. US2007/0106218), entitled “Systems and Methods for Sustained Medical Infusion and Devices Related Thereto”, and International Application Nos. PCT/IL2008/001057 (international publication no. WO2009/016636), entitled “Portable Infusion Device with Means for Monitoring and Controlling Fluid Delivery”, and PCT/IL2009/000388, entitled “Systems, Devices and Methods for Fluid Delivery”, the disclosures of which are incorporated herein by reference in their entireties. An example of a fluid dispensing unit having a rechargeable power supply located in the reusable part is disclosed in co-pending/co-owned International Application No. PCT/IL2009/000266, entitled “Infusion and Sensing Device with Battery Changing and Data Transferring Mechanisms”, the disclosure of which is incorporated herein by reference in its entirety.

The disposable part and/or its components are generally replaced after a relatively short periods of time (e.g., after several days, one week, or any other suitable time frame), or after delivery of a pre-determined amount of therapeutic fluid.

In contrast, the reusable part and/or reusable part's components may be replaced after a longer period of time than that of the disposable part (and/or its components), for example, after three months, six months or any other suitable time frame. Alternatively and/or additionally, any component of the fluid delivery device may be replaced whenever it malfunctions or is depleted, as the case may be.

In some embodiments, a fluid delivery system is provided which, in addition to including a fluid dispensing unit and a remote control, further comprises a skin securable (e.g., adherable) cradle unit. The dispensing unit can be connected to and disconnected from the skin securable cradle unit. The remote control communicates with the dispensing unit to transmit programming instructions, user inputs, notification signals (e.g., status indicators) and/or acquired data.

The fluid delivery device can further include a cannula cartridge unit that includes a cannula, a penetrating member comprising a sharp instrument (e.g., needle) which pierces the skin and is withdrawn after cannula insertion, and a cannula hub. The cannula cartridge unit (or cannula) is configured to be fitted within a “well” of the cradle unit which is a protrusion that defines a passageway enabling the insertion and placement of the cannula in a subcutaneous compartment of the patient's body, and rigidly anchors the cannula hub to the cradle

The cradle unit, cannula cartridge unit, and the disposable part of the dispensing unit may all be disposables (i.e., they may last for 2-3 days).

In some embodiments, a fluid delivery system is provided which comprises a dispensing apparatus for fluid delivery (e.g., insulin) and a sensing apparatus (e.g., sensor) to sense body analytes (e.g., glucose). In some embodiments, a subcutaneously insertable element may include a cannula for fluid delivery and/or a probe for analyte sensing. The subcutaneously insertable element can be used for both dispensing and sensing apparatuses, i.e., both these functions may be implemented in a single device requiring a single insertion site.

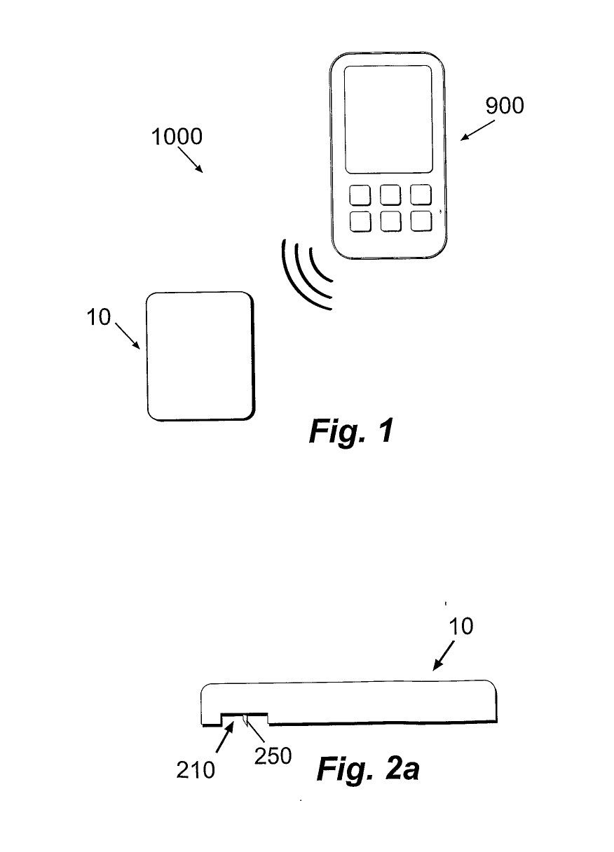

Referring to FIG. 1, a schematic diagram of a fluid delivery system 1000 for medical infusion of therapeutic fluid(s) (e.g., insulin) into a body of a patient is shown. The system 1000 includes a dispensing unit 10 and a remote control unit 900. In some embodiments, and as will become apparent below, the remote control 900 includes a rechargeable power source. An example of a remote control to control a dispensing device is described, for example, in co-pending/co-owned International Application No. PCT/IL2009/000266, entitled “Infusion and Sensing Device with Battery Changing and Data Transferring Mechanisms”, the content of which is incorporated herein by reference in its entirety.

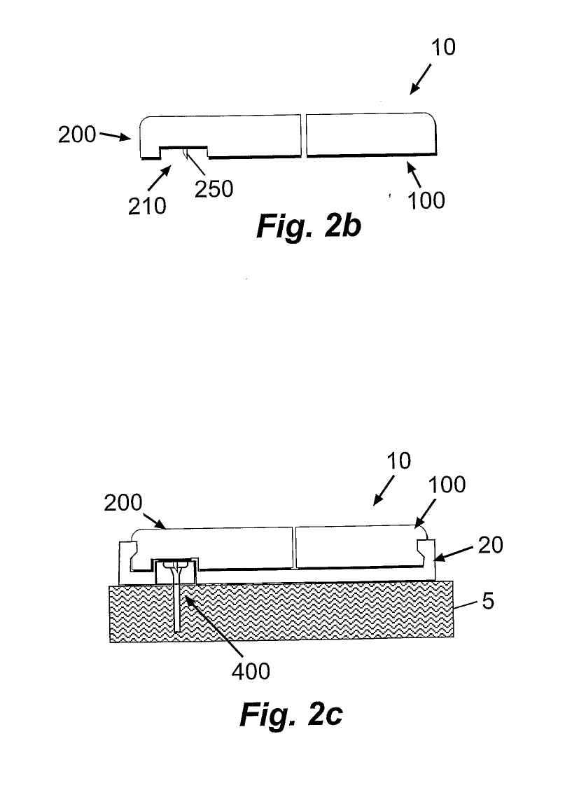

Referring to FIG. 2a, FIG. 2b and FIG. 2c, schematic diagrams of embodiments of a fluid delivery device 10 are shown. In FIGS. 2a-2b, the dispensing unit 10 of the fluid delivery device includes an outlet port 210 and a connecting conduit 250 configured to enable fluid communication with the cannula unit and into the patient's body. The dispensing unit 10 can be composed of a single part (as shown in FIG. 2a) or of two parts (see FIG. 2b). The two-part dispensing unit 10 may include a reusable part 100 and a disposable part 200 that contains an outlet port 210 and a connecting conduit 250. The fluid delivery device can further comprise a cradle unit 20 and cannula cartridge unit 400, as illustrated in FIG. 2c. The two-part dispensing unit 10 can be connected and disconnected to and from the cradle unit 20, which may be a skin securable (e.g., skin-adherable, the skin being designated as reference numeral 5 in FIG. 2c). Fluid communication between the dispensing unit 10 and the patient's body is implemented, in the embodiment of FIG. 2c, through the cannula cartridge unit 400 which is provided with a subcutaneously insertable element (e.g., a cannula).

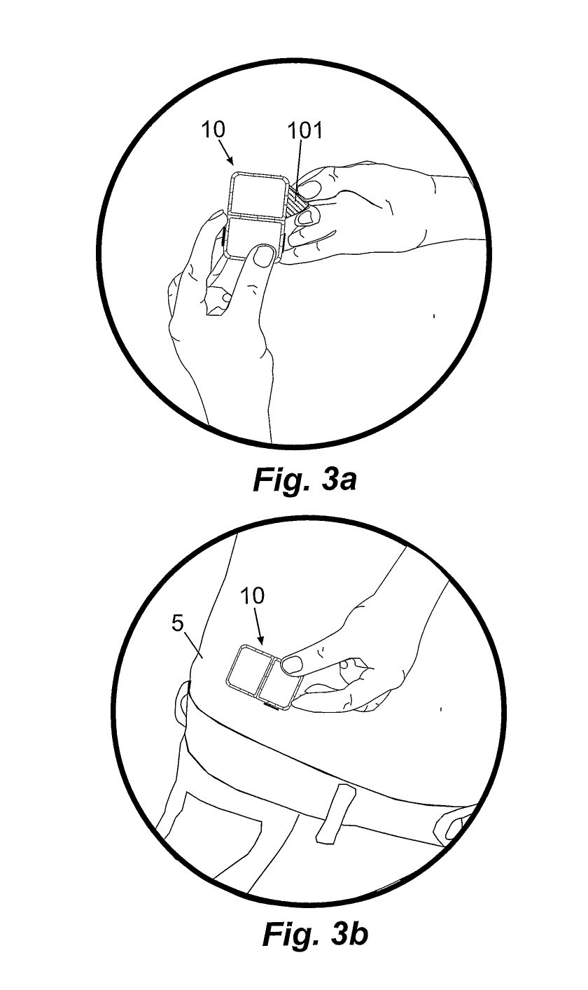

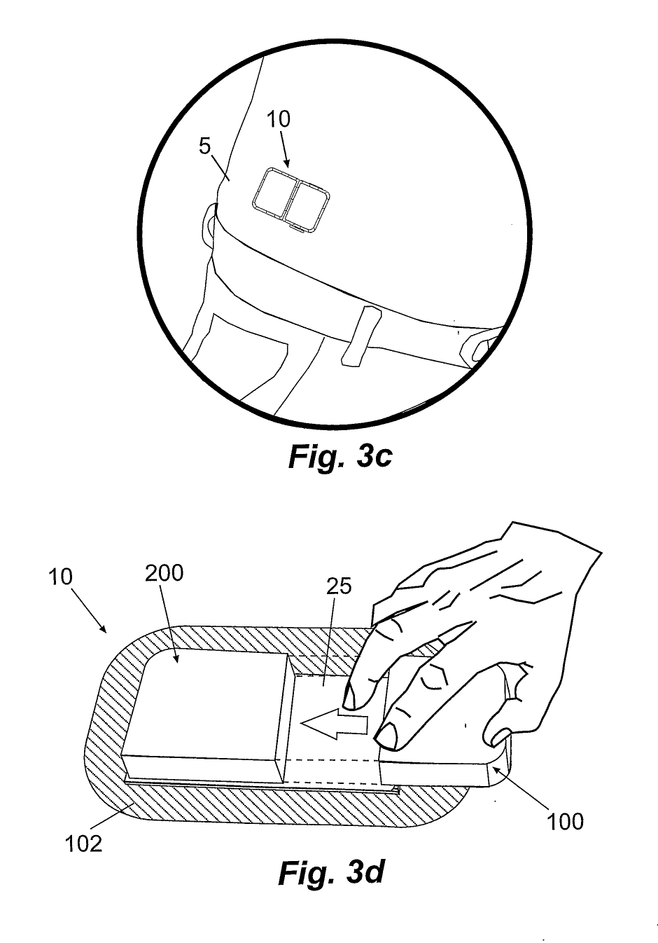

Referring to FIGS. 3a-3d, views and diagrams depicting a procedure to directly secure (e.g., adhere) a two part dispensing unit 10 to skin 5 of a patient are shown. FIG. 3a depicts the removal of an adhesive protective cover 101 from the bottom surface of the disposable part of the dispensing unit. FIG. 3b illustrates the securing (e.g., adhering) of the dispensing unit 10 to the skin 5. FIG. 3c illustrates the operable skin-adhered dispensing unit 10 adhered to the skin of a user/patient. FIG. 3d shows connection of the reusable part 100 to the disposable part 200 that contains a base 25 which is adherable to the skin by virtue of the adhesive tape (designated as 101 in FIG. 3a and as 102 in FIG. 3d).

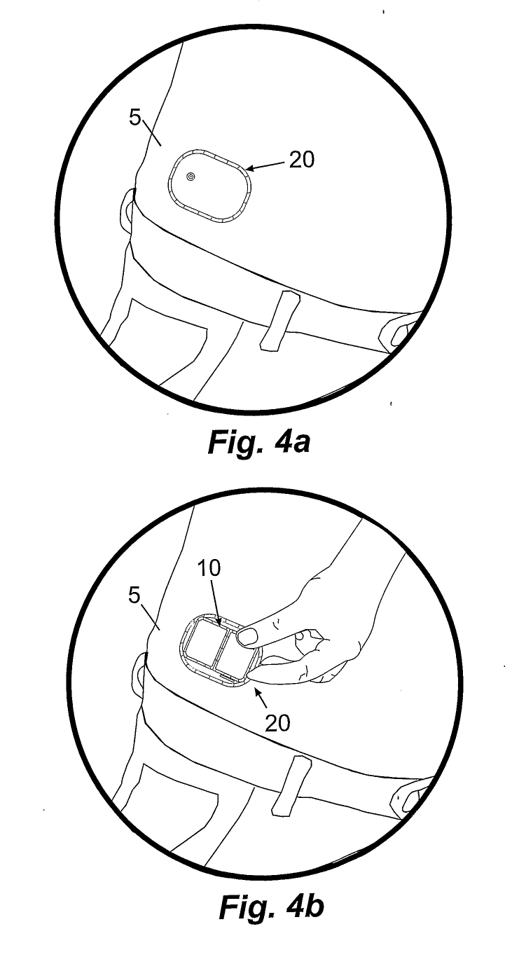

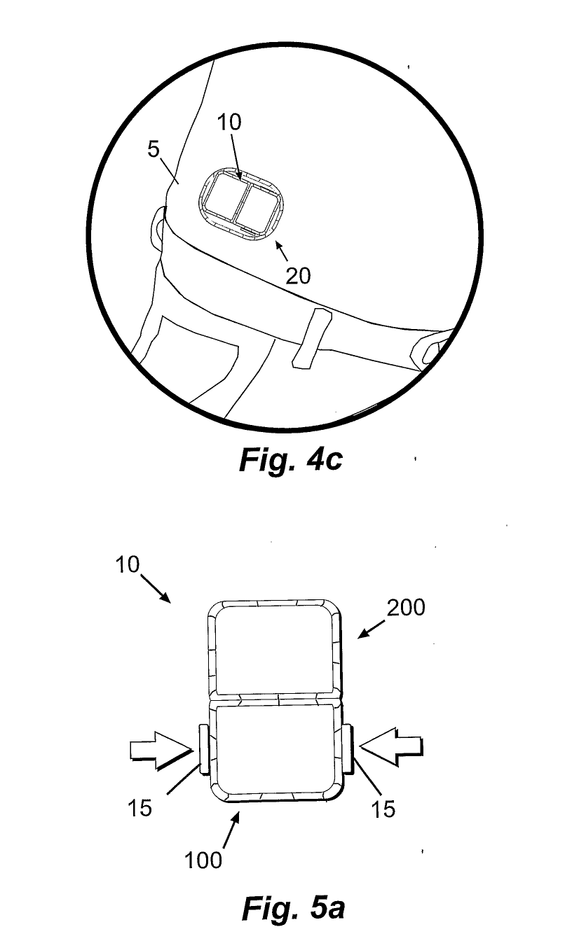

Referring to FIGS. 4a-4c, in some embodiments, the fluid delivery device includes the cradle unit 20 that can be secured (e.g., adhered) to the skin 5. The dispensing unit 10 can be connected to and disconnected from the cradle unit 20 at the patient's discretion. FIG. 4a illustrates the cradle unit 20 adhered to the skin 5. FIG. 4b illustrates the connection of the dispensing unit 10 to the cradle unit 20. FIG. 4c illustrates the dispensing unit 10 connected to the cradle unit 20 and ready for operation.

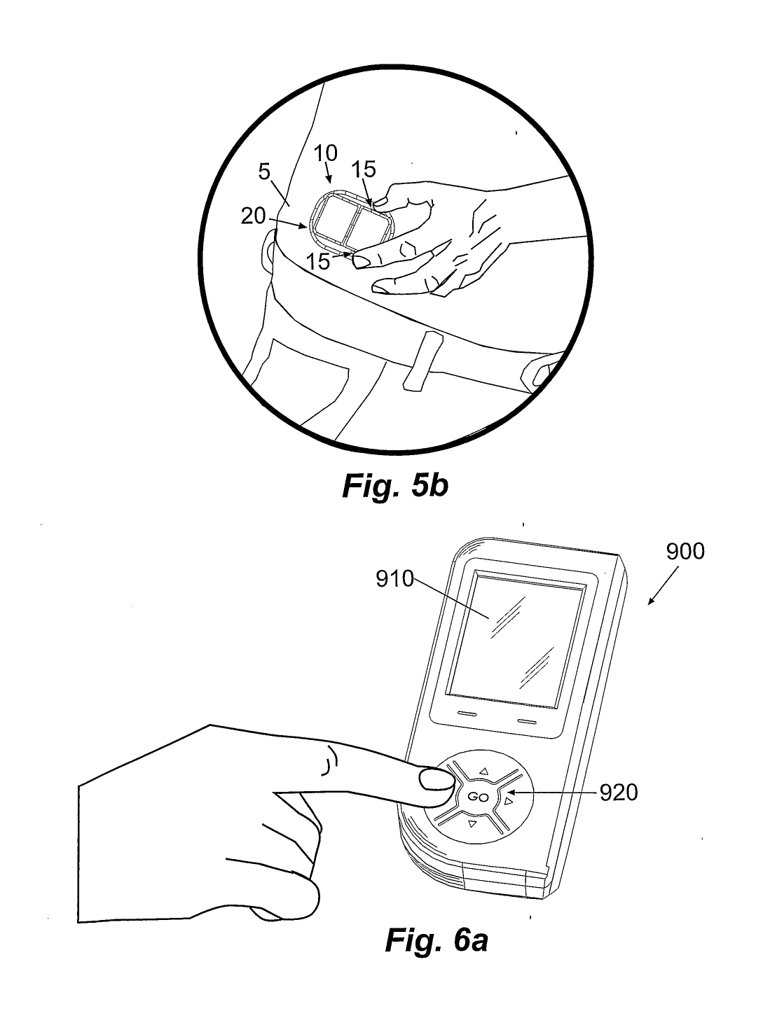

Referring to FIGS. 5a-5b, diagrams illustrating operation of the dispensing unit 10, without a remote control, are shown. A patient can operate the dispensing unit either through use of a remote control or by actuating one or more buttons 15 located on the dispensing unit 10, as illustrated in FIG. 5a. The dispensing unit can also be controlled when attached to the user's skin 5, as shown in FIG. 5b.

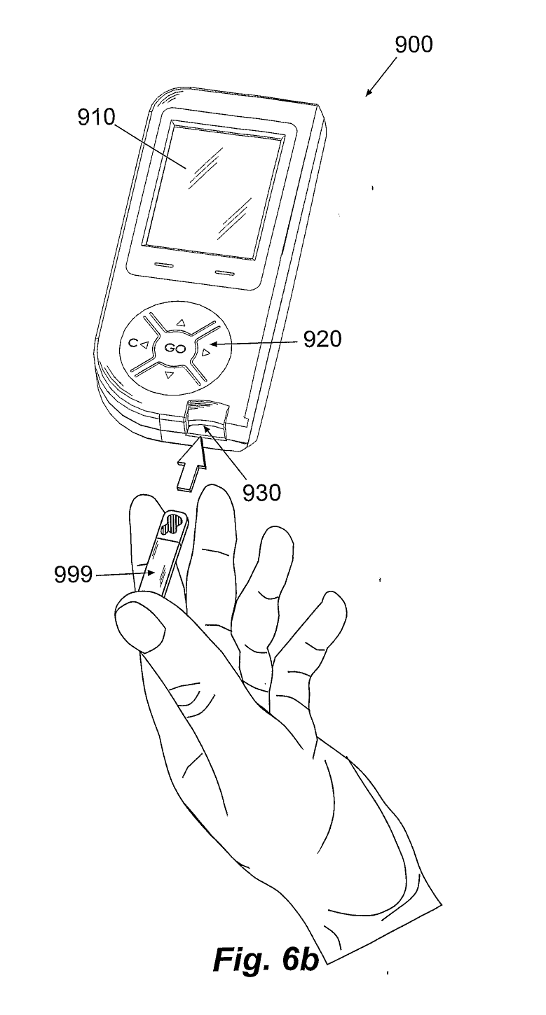

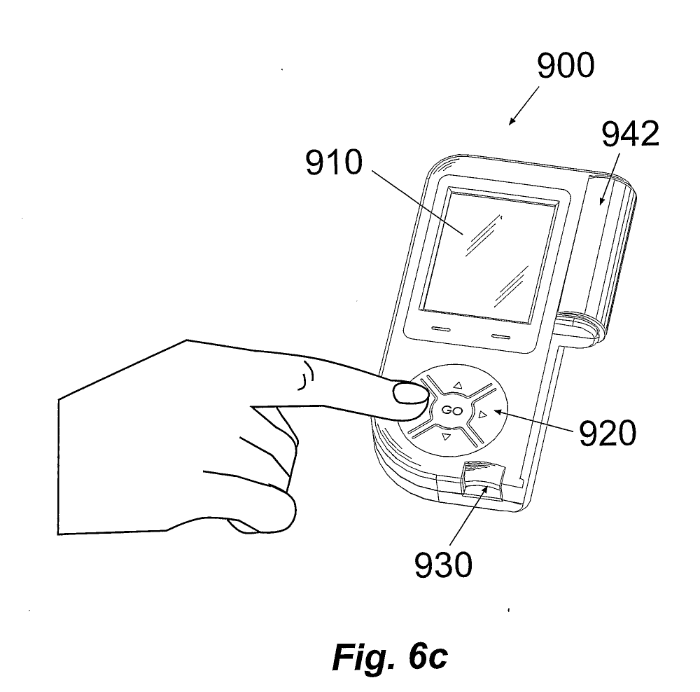

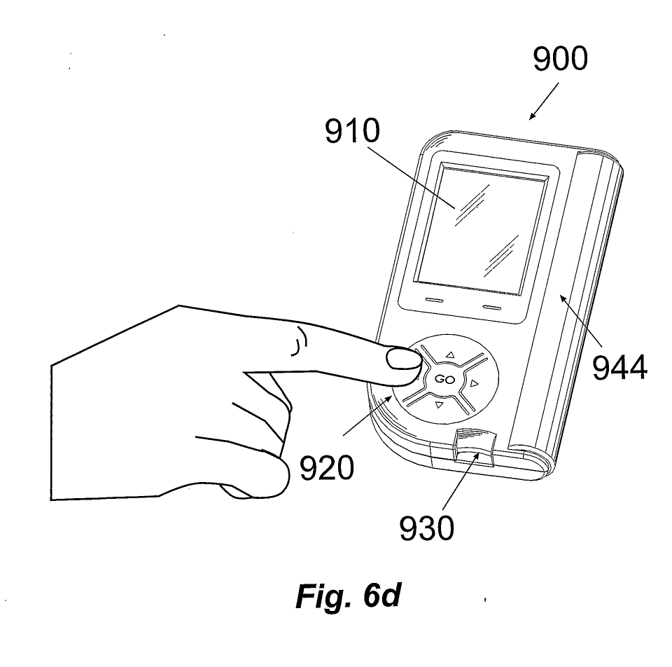

FIG. 6a illustrates a remote control 900, including a display/screen 910, which can be operated with button(s)/switch(s) 920 or through a touch-sensitive screen. Such buttons/switches are described, for example, in co-pending/co-owned International Application No. PCT/IL2008/001001 (international publication no. WO2009/013736), the content of which is hereby incorporated by reference in its entirety. Additional operating buttons/switches may be located on the reusable part of the dispensing device. The reusable part may also include a screen to communicate with the patient as described, for example, in co-pending/co-owned International Application No. PCT/IL2008/001057 (international publication no. WO2009/016636), the content of which is hereby incorporated by reference in its entirety.

The remote control 900 can provide, suspend, and display operating instructions (e.g., basal and/or bolus fluid dispensing commands/instructions), alerts, and warnings (e.g., low battery, low volume of fluid in reservoir).

In some embodiments, the remote control 900 may include a blood glucose monitor (e.g., sensor) which is coupled to the remote control 900, as illustrated, for example, in FIG. 6b. The sensing of glucose concentration levels may be performed by various sensing techniques such as, for example, electrochemical sensing, optical sensing and the like. In some embodiments, a blood test strip 999 can be inserted into a dedicated port 930 and blood glucose level measurement is performed, and the measurements presented on the screen 910 of the remote control.

In some embodiments, a battery chamber, located externally to the remote control, can be affixed to the remote control 900, as shown in FIGS. 6c and 6d. The battery chamber can be adapted to receive one auxiliary battery (see chamber 942 in FIG. 6c), or two auxiliary batteries (see chamber 944, FIG. 6d). A battery chamber typically includes at least one door for opening and closing the chamber, connectors and/or wiring providing electrical connection to the batteries, and at least some of the remote control electronics. Examples for such battery chambers are described, for example, in U.S. Pat. Nos. 4,371,594, 4,218,522, 4,230,777, 4,160,857 and 4,690,878, the contents of which are hereby incorporated by reference in their entireties. According to some embodiments, batteries installed in the battery chamber are used as a power source when the rechargeable power source of the remote control is depleted and/or based upon a user's decision to power the device with the auxiliary (e.g., non-rechargeable) battery. In some embodiments, the auxiliary batteries may be removed from the battery chamber to reduce encumbrance.

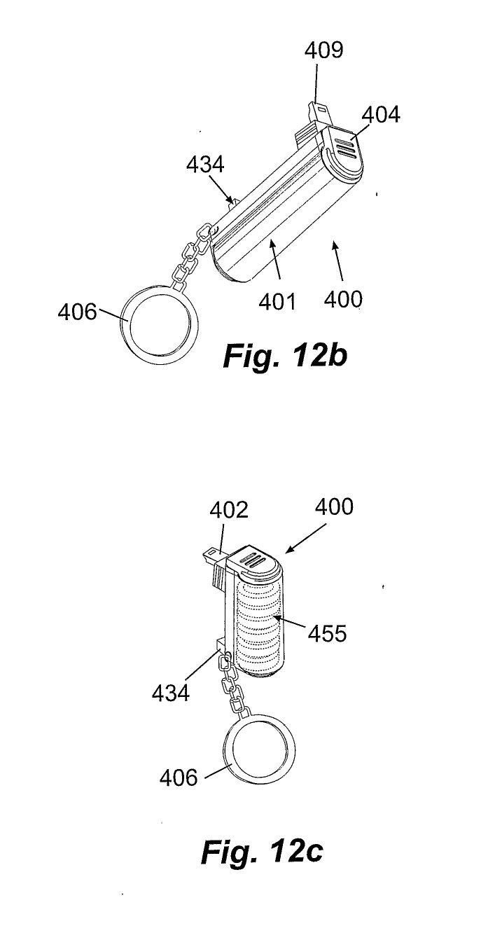

In some embodiments, the device may include a detachably connectable housing that includes a battery chamber for at least one auxiliary battery, as shown, for example, in FIGS. 12a to 12c.

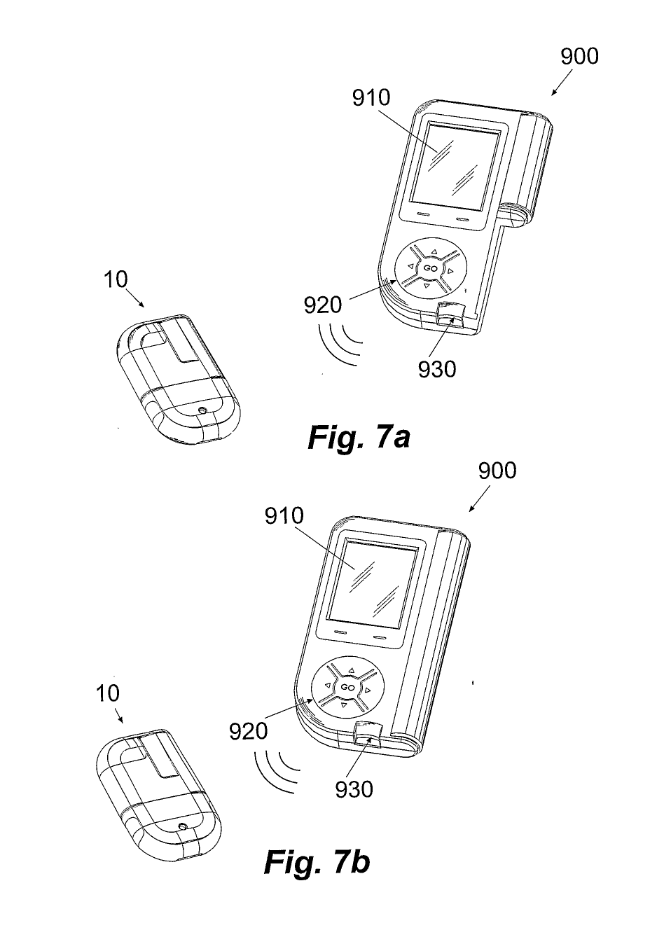

Referring to FIGS. 7a and 7b, views and diagrams illustrating a remote control unit 900 that includes a battery chamber for one auxiliary battery (FIG. 7a) or for two auxiliary batteries (FIG. 7b) are shown. The remote control 900 can communicate with the dispensing unit 10 via a wireless communication link and/or any other suitable mechanism, including, for example, an induction-based communication mechanism, RF transmission, IR transmission, wired-based communications mechanisms, etc. Communication between the remote control 900 and the dispensing unit 10 may be unidirectional (i.e., one-way communication) or bi-directional (i.e., two-way communication).

In some embodiments, the remote control 900 may be implemented using, for example, a PC, laptop, watch, cellular phone, iPod, Personal Digital Assistant (“PDA”), other types of processor-based devices, or any other type of remote commander/controller.

In some embodiments, the remote control 900 can further include dedicated software implementations, including, for example, implementations for bolus selection methods and implementations for Carbohydrate-to Insulin Ratio (“CIR”) estimations (as described, for example, in co-pending/co-owned U.S. patent application Ser. Nos. 12/051,400 (U.S. publication no. 2008/0234663) and 12/143,601 (U.S. publication no. 2009/0018406), respectively, the contents of which are hereby incorporated by references in their entireties.

In some embodiments, the remote control unit 900 may be used to indicate the amount of units of insulin (e.g., 190U) remaining in the reservoir, as well as numerous other functions regarding the setup and operation of the dispensing unit and/or device/system as a whole. The remote control unit 900 can further indicate readings and/or inputs from a glucose sensor (a “stand-alone” glucometer, a sensor incorporated in the fluid delivery device or a sensor which is accommodated in the remote control itself).

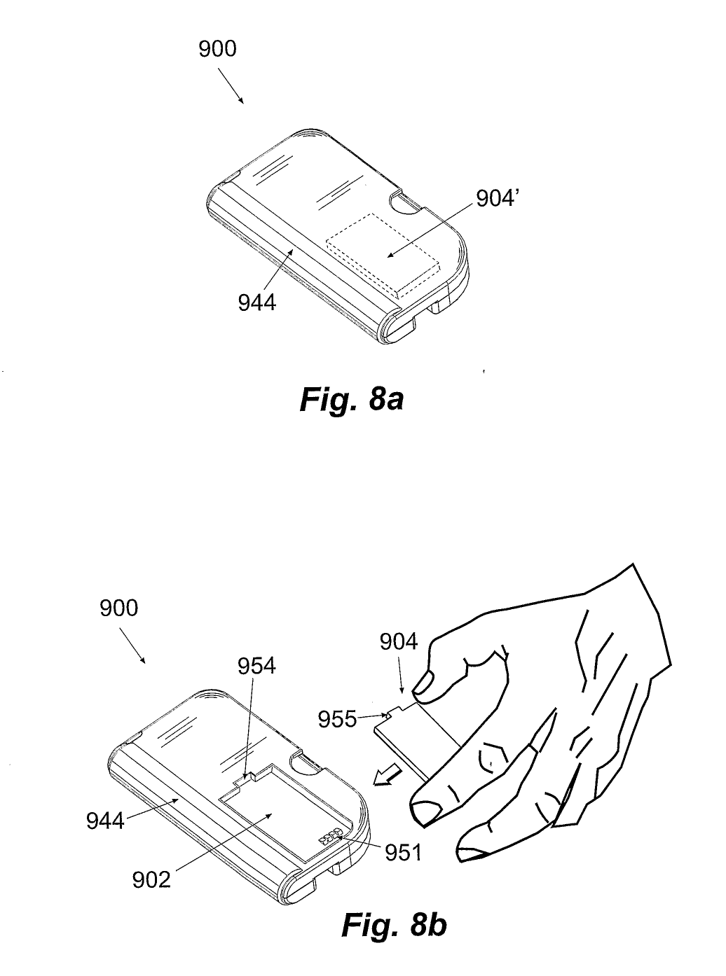

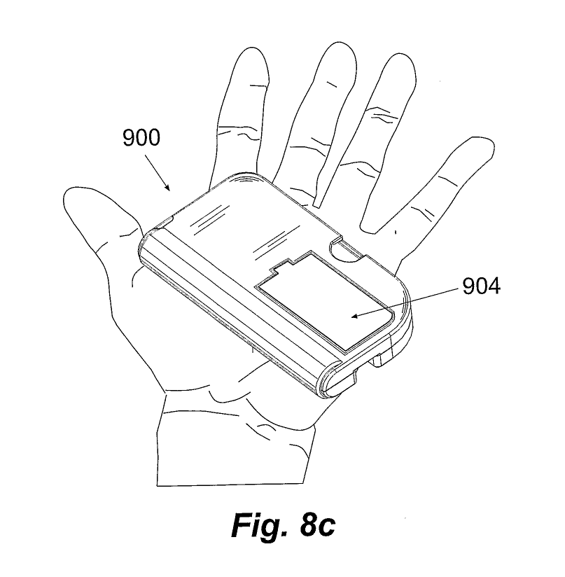

With reference to FIG. 8a, FIG. 8b and FIG. 8c, diagrams and views illustrating embodiments of a remote control 900 that includes a battery chamber for two auxiliary batteries 944 affixed to the remote control 900 are shown. The remote control 900 includes rechargeable batteries 904 and 904′, which provide power to the remote control electrical components. In some embodiments, the rechargeable battery 904′ is installed inside the remote control 900 as illustrated in FIG. 8a. In some embodiments, the remote control may be connectable to a detachably connectable rechargeable battery 904, as depicted, for example, in FIG. 8b and FIG. 8c. The detachably connectable rechargeable battery 904 can be attached into a recess 902 defined on the in the remote control 900, as shown in FIGS. 8b and 8c. FIG. 8b also illustrates electrical connectors 951 located in recess 902 to provide electrical coupling between the rechargeable battery 904 and the remote control 900. The rechargeable battery 904 can be mechanically secured to the remote control 900, for example, using a latch 955 to be engaged in a locking configuration with a notch 954.

In some embodiments, the power is provided from the rechargeable battery 904 by default, until the power level, or the charge level, of the rechargeable battery is reduced to some pre-determined power/charge level.

A notification unit (also referred to as a notifier or indicator) may be used to provide status indications to the user based on the battery's charge level and/or the power consumption regime of the remote control components (e.g., the power consumption of the display, RF module, processor, etc.). For example, a suitable indication may be provided by the notifier in circumstances in which the battery charge is determined to have been depleted or when it is determined that the battery's charge is about to be depleted (e.g., based on a computed charge level and/or on the power consumption behavior of the remote control). The electrical charge stored in a battery may be correlated to other parameters of the rechargeable battery, such as, for example, the battery's voltage, power, current, temperature, etc., thus enabling determination of the charge level in the rechargeable battery based on indirect measurement of those characteristics of the battery.

For example, a lithium ion rechargeable battery has an operational voltage that correlates to the charge of the battery. Such lithium ion batteries have a typical operation voltage range of 2.7 v to 4.2 v. Power may be provided from the lithium ion battery used to power the remote control as long as its voltage is, in some embodiments, above 2.7 v. When the voltage of the rechargeable battery drops to approximately 2.7 v, the remote control is configured, in some embodiments, to draw/consume energy/power from an auxiliary battery, such as, for example, the one or more batteries installed in the chamber 944. In some embodiments, messages and/or notifications may be provided to the user when the rechargeable battery voltage reaches 3.0 v, 2.85 v and/or when the unit switches to auxiliary power, such as when the voltage of the rechargeable battery reaches 2.7 v.

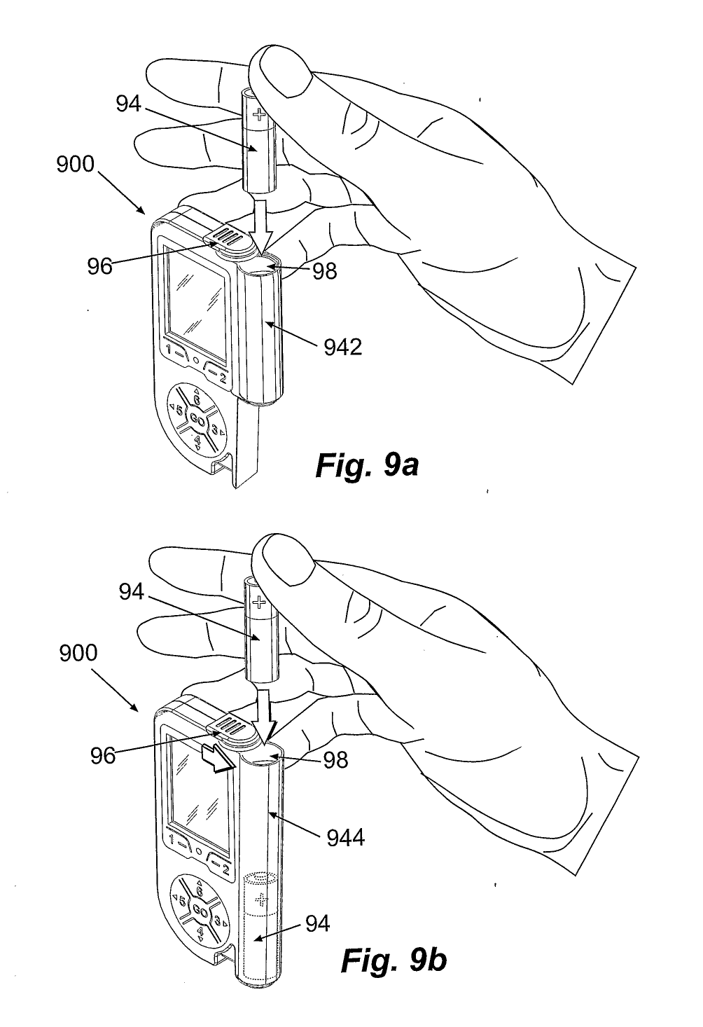

FIG. 9a and FIG. 9b are views and diagram depicting the insertion of an AAA battery 94 into, respectively, battery chambers 942 and 944 of the remote control 900. As shown in FIG. 9a, in some embodiments, the remote control 900 includes a chamber 942 for one AAA battery, and in some embodiments, as shown in FIG. 9b, the chamber 944 may be structured to receive two AAA batteries. The chamber may be structured to accommodate additional batteries and/or different battery types. The one or more auxiliary batteries may be inserted or removed from the battery chamber at the user's discretion, i.e., installing the one or more auxiliary batteries when the rechargeable battery is depleted and removing them to reduce the weight or the remote control when the auxiliary batteries are not required. The one or more batteries 94 are inserted within the chamber 942 or 944 via an opening 98 of the battery chamber. The opening 98 can be opened and closed using by a door (or cap) 96 that includes, in some embodiments, conductive material and/or wiring for electrically connecting the one or more batteries to the electrical system (e.g., electronics) of the remote control.

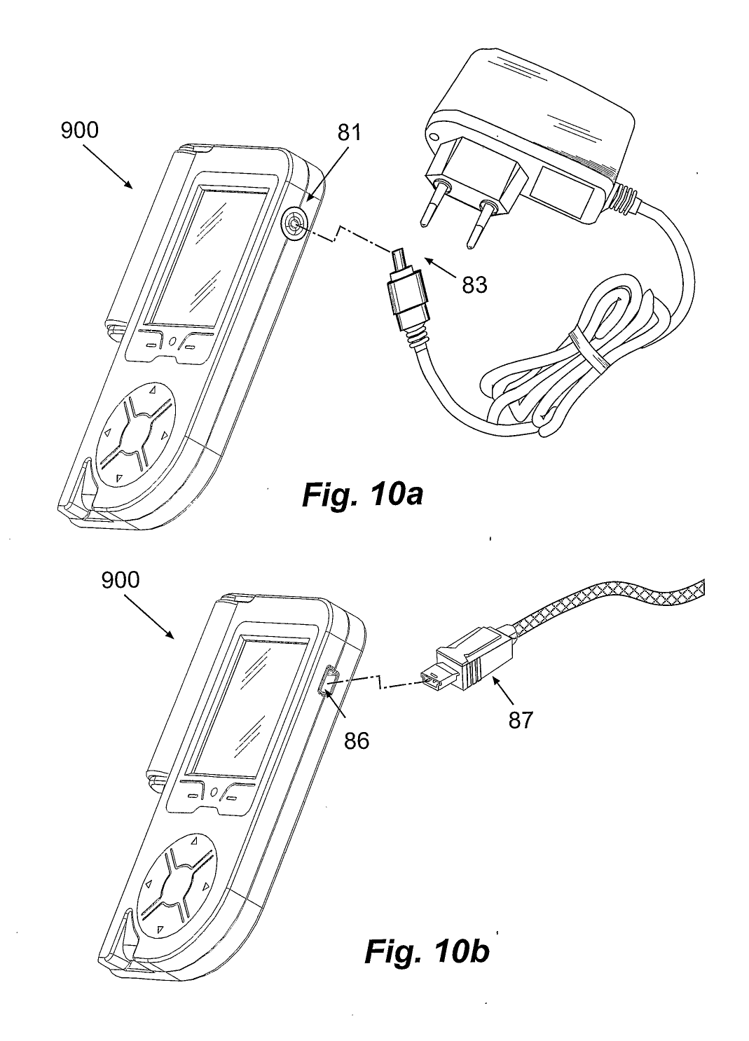

FIG. 10a depicts a remote control 900 with a charger port (or slot) 81 to connect the remote control to an external high power source for charging the rechargeable battery (“external high power source” generally refers to external power sources that are accessible through standard plug/outlet arrangements such as conventional home/office AC power outlets, car lighter socket outlets, etc.) In some embodiments, a DC plug can be connected to the charger port 81. The power can be provided from a car lighter socket (also referred to as “cigar lighter receptacle”), from an AC power socket (via transformer and/or rectifier circuitry) and/or from other types of power sources.

FIG. 10b illustrates a remote control 900 with a USB socket 86. A USB plug 87 connectable to the USB socket 86 can provide power to charge the rechargeable battery and/or for the remote control's electronics. The USB (in some embodiments, a mini-USB, or other variations of USB, may be used) connection may also enables data transfer to and from the remote control, enabling the user to backup his/her personal setting, program, etc., to provide reports on the therapeutic treatment or to otherwise control the remote control and/or the dispensing unit,

In some embodiments, the external high power required to charge the rechargeable battery can be provided to the remote control 900 wirelessly, e.g. by induction, RF transmission, etc., or it may be transferred to the dispensing unit by wires. Procedures to transfer electrical charge to a rechargeable dispensing device are described, for example, in co-pending/co-owned U.S. Patent Application No. PCT/IL2009/000266, entitled “Infusion and Sensing Device with Battery Changing and Data Transferring Mechanisms”, the content of which is hereby incorporated by reference in its entirety.

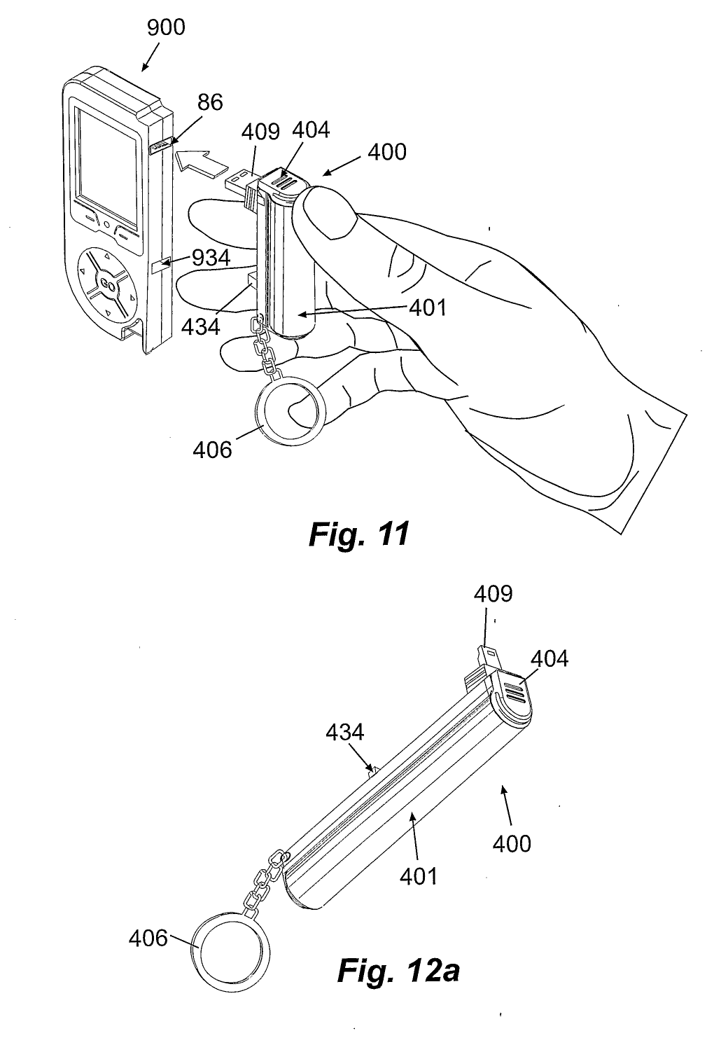

FIG. 11, FIG. 12a, FIG. 12b and FIG. 12c are diagrams and views illustrating embodiments of a detachably connectable auxiliary power unit 400. The auxiliary power unit 400 includes a housing 401 which is detachably connectable to the remote control 900. The auxiliary power unit 400 includes, in some embodiments, a USB plug 409 connectable to a USB socket 86 of the remote control 900 and a fastener 434 (a notch) that anchors the auxiliary power unit to the remote control 900 when fitted into a recess 934 in the remote control 900. The fastener 434 is, in some embodiments, a plastic clip, although other forms of attachments can be used, including magnets, screws, clip on and the like. The recess 934 has a substantially complementary shape to the shape of the fastener 434. In some embodiments, the auxiliary power unit 400 also includes a door 404 and key ring 406 for carrying the casing 400 when not attached to the remote control 900.

In some embodiments, a different housing 401, configured to receive different batteries, e.g., two AAA batteries (as shown in FIG. 12a), one AAA battery (as shown in FIG. 12b) or six button size batteries 455 (as shown in FIG. 12c), may be used. Other embodiments may use different types and/or different number of batteries. The housing 401 includes a USB plug 409 and a fastener 434, thus enabling any one of them to be connected to remote control 900. Accordingly, different types of batteries can be used to constitute an auxiliary power source to power a remote control (as used herein, an “auxiliary power source” generally refers to battery-based, typically non-rechargeable battery-based, power sources). The auxiliary power unit 400 typically includes wiring, connectors and electronic components required for connecting the batteries and remote control. In some embodiments, the remote control is implemented without unduly heavy (weight-wise) or expensive components, such as a controller, a fuel gauge, a sensor and the like, to thus render the remote control light in weight and relatively low in cost. In some implementations, relatively more expensive components may be included in the implementation of the remote control.

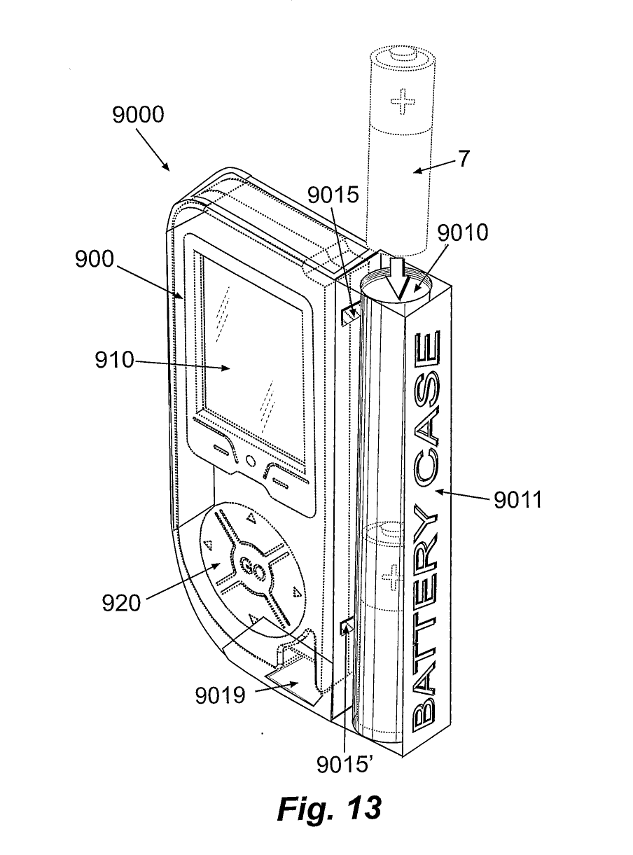

Referring to FIG. 13, a perspective view of a case 9000 to encase a remote control 900 and an auxiliary batteries chamber 9011 is shown. The case includes electrical connectors 9015 and 9015′ that connect at least one auxiliary battery 7 placed in the chamber 9011 to the remote control 900. The remote control display 910 and control buttons 920 can be accessed while the remote control 900 is encased in the case 9000, thus enabling the user to operate the remote control 900 while it is located inside the case 9000. The case can also include an opening 9019 to provide access to a glucose sensor dedicated port (not shown in FIG. 13). The auxiliary batteries chamber 9011 further includes an opening 9010 to insert and remove the at least one auxiliary battery. A removable cap (not shown) for closing the opening 9010 may also be included. The embodiment depicted in FIG. 13 may be beneficial to enable the patient to perform outdoor activities, such as camping, traveling, hiking, fishing, etc., as it protects the remote control and reduces the need to charge the rechargeable battery.

In some embodiments, the auxiliary batteries chamber 9011 may be detachably connectable to the case 9000, thus providing a light weight case 9000.

In some embodiments, the case 9000 may protect the remote control against various hazards (e.g., sharp objects, impacts, falls and the like) and/or may be water tight. A water tight case may include a transparent portion so that the display 910 can be read, and may optionally include a flexible portion to enable actuation of the buttons 920 or other elements of a user-input interface to control the remote control.

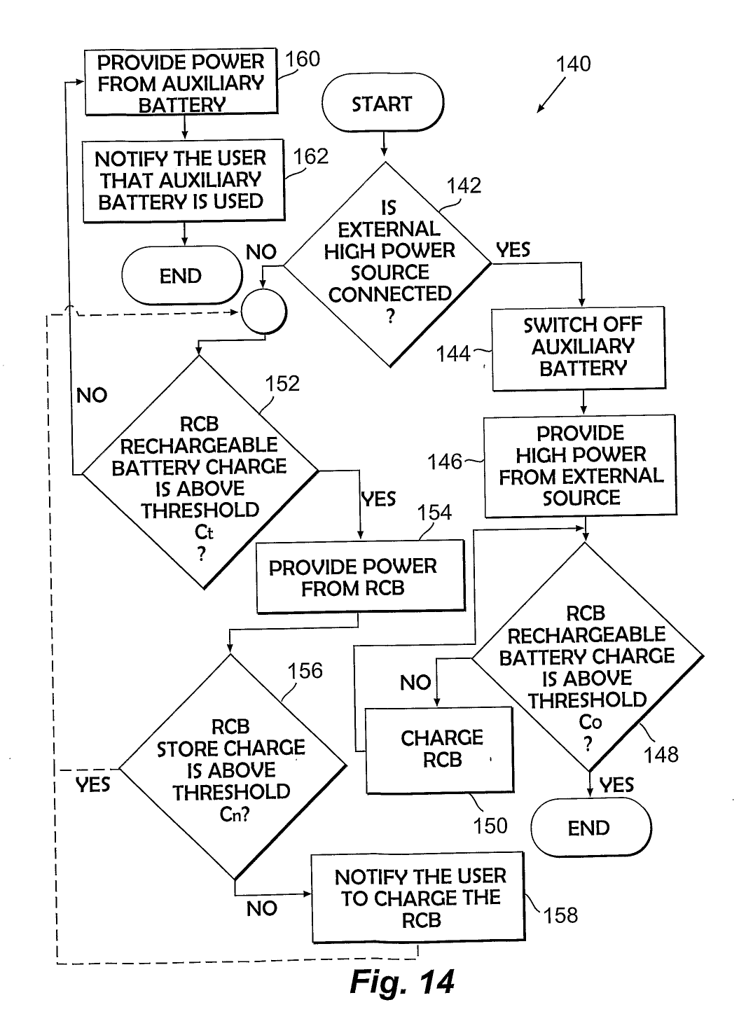

Referring to FIG. 14, a flow chart of a procedure 140 for monitoring and controlling the power supply to a remote control, such as, for example, the remote control unit 900 is shown. In some embodiments, connection to external high power supply or source (i.e., high power source such as from an AC power grid source) is initially checked 142, using, for example, an analog-to-digital converter (ADC). If an external high power source is connected it will be used as the power source and the rechargeable battery will be charged using power from the external high power source, if needed. When no external high power source is connected, the rechargeable battery is used as the power source and provides power 154 as long as it has enough charge (as determined, for example, at 152). When no external high power source is connected and the rechargeable battery is depleted (as determined at 152), an auxiliary power source located externally to the remote control may be used as power source to provide power (as determined at 160) to the remote control. Alternative and/or supplemental procedures to the procedure depicted in FIG. 14 may be applied.

More particularly, as shown in FIG. 14, detection of external high power source is performed 142 by, for example, measurement of the voltage connected to a USB socket and/or a charger socket (shown in FIGS. 10a and 10b). When an external high power source is connected, the externally located auxiliary power source is disconnected 144 (e.g., by electrical switching) to avoid charging of a primary battery and/or depletion of the auxiliary power source while other power source are being used. In some embodiments, the auxiliary power source cannot be connected while the external high power source is connected, e.g., both of them can be connected to the remote control only via the same connector and/or the connector for the external high power source is blocked by the externally located auxiliary battery chamber (or vice versa). Power is thus provided 146 to the remote control from the external high power source. In some embodiments, when an external high power source is connected to the remote control, the power source may be used to charge the rechargeable battery and to power the other electrical/electronics components. Alternatively and/or additionally, in some embodiments, power to the other components is provided from the rechargeable battery, which in turn can be charged from the external power source.

Thus, the Rechargeable Battery (RCB) state of charge (SOC) is determined 148. According to some embodiments, the voltage of the RCB is used as the basis for calculating SOC or the remaining capacity. In some embodiments, when determining SOC to measure the battery's charge level, the battery's temperature is also measured because SOC can vary widely depending on voltage level and temperature. Temperature sensing can also be used as safety feature that disconnects the charger if the cell temperature is too high (e.g., above 80° C.). Other precautions may also be used, such as a mechanical pressure switch that interrupts the current path if a safe pressure threshold is exceeded.

In some embodiments, SOC is determined based on the current entering and leaving the RCB as a basis for performing a remaining capacity computation. The charge transferred in or out of the RCB is determined by accumulating the current drain over time. This technique, known as Coulomb counting, is considered to have a relatively high accuracy. According to some variations, determining the current may be performed using a fuel gauge component. The current can be determined, for example, by measuring the voltage drop across a low ohmic value, high precision, series, sense resistor. Other techniques may be used.

Thus, the RCB is charged 150 if its charge is below a defined threshold c₀ (as determined, for example, at 148). In some embodiments, c₀ may be defined as 90% of full charge (SOC=0.9). However, in some embodiments, other pre-determined threshold values may be used.

If it is determined, at 142, that an external high power source is not connected, a determination is made 152 of the RCB's charge level, which may be represented as a SOC level (i.e., a percentage value of the charge fullness of the RCB). In some embodiments, cₜ is defined as 30% of full charge (SOC=0.3). The pre-determined threshold cₜ may be representative of an insufficient charge level of the RCB to direct power from the RCB (e.g., for a predetermined period of time). Thus, if the charge level of the rechargeable battery exceeds the cₜ threshold, then the RCB may be used as the power source to power 154 the remote control, and may then be directed from the RCB to power, at least partly, the remote control. When it is determined that the charge level (be it a percentage value representative of the fullness of the rechargeable source, a value representative of the actual charge level of the RCB, etc.) of the RCB is below the pre-determined threshold, power is provided 160, for example, from one or more auxiliary batteries electrically connectable to the remote controller. When power is supplied to the rechargeable battery (e.g., when it is being recharged) or from the rechargeable battery, the RCB's SOC is monitored. According to some embodiments, the RCB and another source (e.g., an externally located auxiliary battery or high power source) may concomitantly provide power. In some embodiments, only one source at a time may be used to power the remote control and thus only one source may be enabled as the active power source at any given time.

When power is provided from the RCB, a determination is made 156 of whether the RCB's determined charge level (which may be represented as an SOC value) exceeds a pre-determined threshold, cₙ. The pre-determined threshold cₙ may be representative of a charge level of the RCB sufficient to direct power from the RCB (e.g., for a predetermined period of time). In some embodiments, cₙ is defined as 50% of full charge (SOC=0.5). If the determined charge level exceeds the threshold cₙ, power may continue to be directed from the RCB to power, at least partly, the remote control. When the determined charge level is below the threshold cₙ, power can still be drawn from the RCB to power the remote control, but the charge level of the RCB may be getting to be too low, and therefore the RCB should be recharged. Accordingly, the user is notified 158 that it has to recharge the RCB (e.g., by connecting an external high power source to the remote control). In some embodiments, at least one of the thresholds, cₙ, cₜ, and c₀ can be adjusted. The adjustment of the thresholds cₙ, cₜ or c₀ may be automatic and/or determined by the user. Automatic adjustments can be conducted based on the power consumption of the remote control, RCB state of health (SOH, which is representative of the general condition of a battery and its ability to deliver the specified performance as compared to a fresh battery); temperature, charging time, and the like.

At 160 the auxiliary battery is used to provide power to the remote control. In some embodiments, the voltage of the auxiliary power source, which can include one or more batteries, should be at least 0.9 v and less than 6 v. In some embodiments, the voltage range of the auxiliary power source is between 1.3 v to 4.5 v. At 162, a notification is provided to the user, advising her/him that the auxiliary power source is in use. According to some embodiments, indications regarding the active power source are provided to the user continuously or periodically (e.g., every few minutes, when programming the remote control, when the SOC changes, etc.). Additionally and/or alternatively, indications regarding the status of at least one of the power sources, e.g., whether the power source is connected/disconnected, the power source's SOC, charging progress, etc., may also be provided.

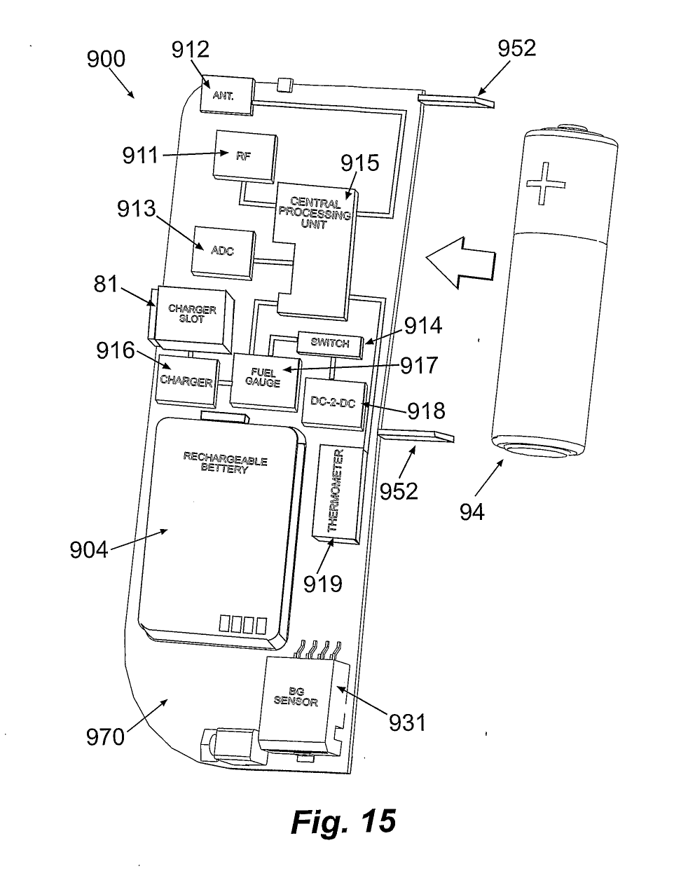

Referring to FIG. 15, a diagram of an arrangement of some of the electronic components of the remote control 900 is shown. In some embodiments, the remote control's unit/components are arranged on a printed-circuit-board (PCB) 970. Other electronic arrangements and/or implementations of the remote control may be used. The PCB 970 provides electrical coupling between the components/unit and mechanical support. The electronic unit/components may include:
An RF module 911 and an antenna 912 for RF communication with the dispensing unit.
A CPU 915 that controls and regulates some, or all, of the remote control processes and operations.
A charger slot 81 adapted to be connected to and receive power from an external DC connector.
An analog-to-digital converter (ADC) 913 used to measure the rechargeable battery voltage. It can also be used to measure voltage of other components and/or the voltage of the high power source and/or the auxiliary battery located externally to the remote control.
A rechargeable battery 904 which may be used as a power source.
A charger 916 configured to control the current and voltage applied to the rechargeable battery 904 to charge it.
A fuel gauge 917 to measure the accumulated energy added to and removed from the rechargeable battery, thus enabling making substantially accurate estimates of the rechargeable battery 904 state of charge. The fuel gauge 917 can also measure the amount of energy removed from an auxiliary battery 94 to thus estimate the remaining charge in that battery.
A switch 914 for changing the active power source of the remote control 900 by connecting and disconnecting, as required, the charger slot 81, the rechargeable battery 904 and/or the auxiliary battery 94. Other switching devices may be included in the remote control 900 for its proper functioning.
A DC-to-DC converter 918 (e.g., a buck converter) to convert the voltage supplied from the power source to the voltage required by other electronic components such as the CPU 915, the RF module 911, display, etc.
A thermometer 919 to measure the temperature of the rechargeable battery 904. Thus, in some embodiments, the thermometer should be located in close proximity to the rechargeable battery.
Battery connectors 952 to connect one or more auxiliary batteries.

It should be noted that many other electronic components may be included in remote control 900, including resistors, capacitors, switches, buttons and other modules. It should also be noted that in some embodiments, at least some of the components may be included in a separate housing, e.g., a detachably connectable rechargeable battery disposed in a housing, may also include a charger in that housing. Also, some of the components may perform more than one function. For example, the thermometer 919 may be included in the RF module 911. Furthermore, some functions can be provided by more than one component and there can be more than one module with a similar functionality.

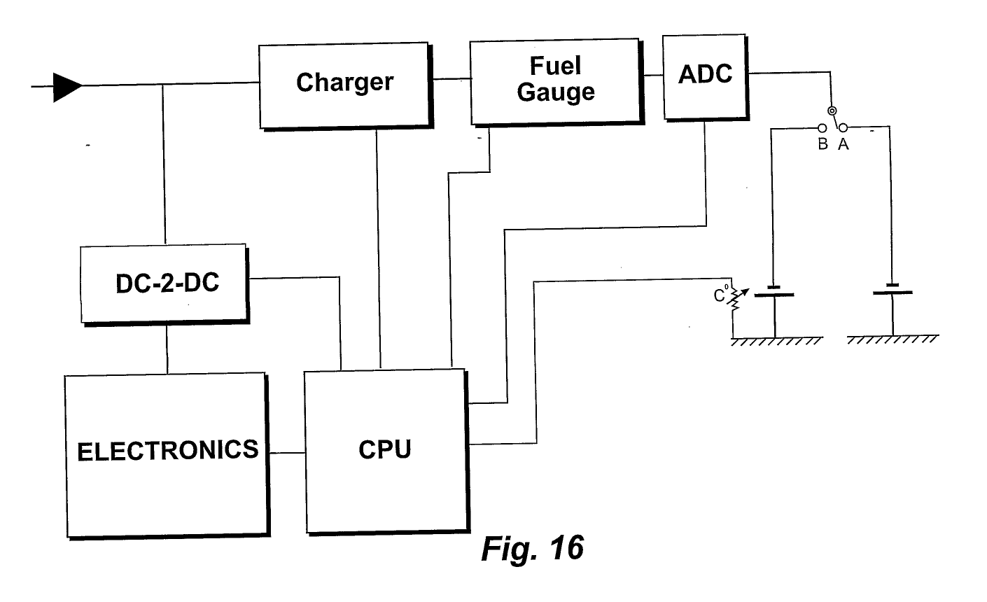

Referring to FIG. 16, a block diagram depicting the circuit configuration of an implementation of a remote control is shown. The remote control can be powered by a rechargeable battery, an auxiliary battery located externally to the remote control and/or a high power source. In some other embodiments, power may be provided from two power sources simultaneously, e.g., from a rechargeable battery and an auxiliary battery or from a rechargeable battery and a high power source. In some embodiments, preference may be given to powering the remote control using the rechargeable battery.

The charger charges the rechargeable battery when the remote control is connected to external power source. Charging of the rechargeable battery may be based on the SOC. The SOC may be determined (e.g., by the CPU) based on the current and/or charge provided (drawn) from the battery (e.g., by a fuel gauge), the terminal voltage of the battery (e.g., measured with ADC) or by using other measurement techniques. At least one switch is included to connect and disconnect the rechargeable battery as required. Specifically, during normal usage the rechargeable battery is connected to other electronics via the fuel gauge, charger and DC-to-DC that alters the power source voltage to the voltage required by other electronics components (CPU, display, RF module, etc.). According to some embodiments, the rechargeable battery is disconnected according to its SOC to prevent over charge, over discharge and/or other harmful effects. For example, the rechargeable battery used may be a lithium-ion-polymer battery whose SOC correlates to its voltage. The working range of such a battery may be 2.9 v to 4.2 v. When the battery's voltage is out of this range (or some other pre-defined range), the battery may be disconnected. It should be noted that commercially available lithium ion packs may contain protection circuits that limit the charge voltage to 4.30V/cell, which is 0.10 volts higher than the voltage threshold of the charger.

According to some embodiments, when the rechargeable battery charge is too low to power the remote control (e.g., as determined based on a comparison to some pre-determined threshold), the rechargeable battery is electrically disconnected from the components/units of the remote control and the auxiliary battery is electrically connected to the remote control to provide power. In some embodiments, when the rechargeable battery charge is determined to have reached some value, both the auxiliary battery and the rechargeable battery may be connected to provide power. A fuel gauge may be included to monitor the SOC of each battery.

In some embodiments, the auxiliary battery is disconnected, for example, by a switching device (e.g. switch) when a high power source is connected. In some embodiments, the auxiliary battery and the external power source can be connected via the same connector to the remote control components/units so that only one of them is connected at any given time.

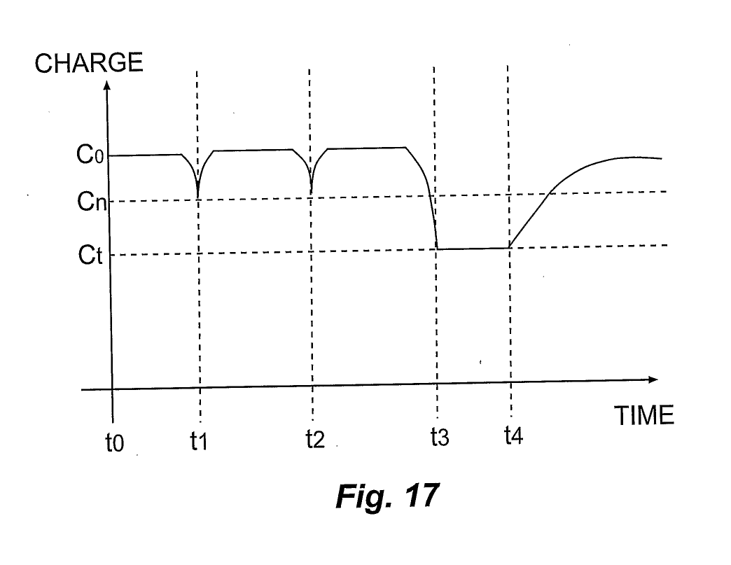

Referring to FIG. 17, a graph showing the charge levels of a rechargeable battery during operation of a remote control employing the rechargeable battery is shown. There are three cycles of charging and usage of the battery, namely, at the periods t₀-t₁, t₁-t₂ and t₂-t₃, the charge c₀ at the beginning of each cycle t₀, t₁ and t₂ is the maximal charge allowed. During usage, the battery's charge depletes until the battery is recharged at t₁, t₂ and t₄ or when it reaches the minimal charge allowed cₜ at t₃. In some implementations, upon reaching minimal charge cₜ the rechargeable battery is no longer used as the power source of the remote control (e.g., it is disconnected), and thus the charge remains the same, namely, cₜ, until it is recharged at t₄. In some embodiments, the user may program the remote control to further use the rechargeable battery even if it has been depleted to the minimal allowed charge, for example, in cases of emergencies.

In some embodiments, notifications are provided to the user regarding the battery charge, e.g., a “Fully charge” notification, a “No charge” notification, a “Switching to auxiliary battery” notification, etc. In some embodiments, an alarm will be provided to the user when the battery has to be recharged (e.g., “recharge required” notification). For example, when the charge drops to cₙ, an alarm is produced to notify the user so that he/she can charge the battery or install an auxiliary power source.

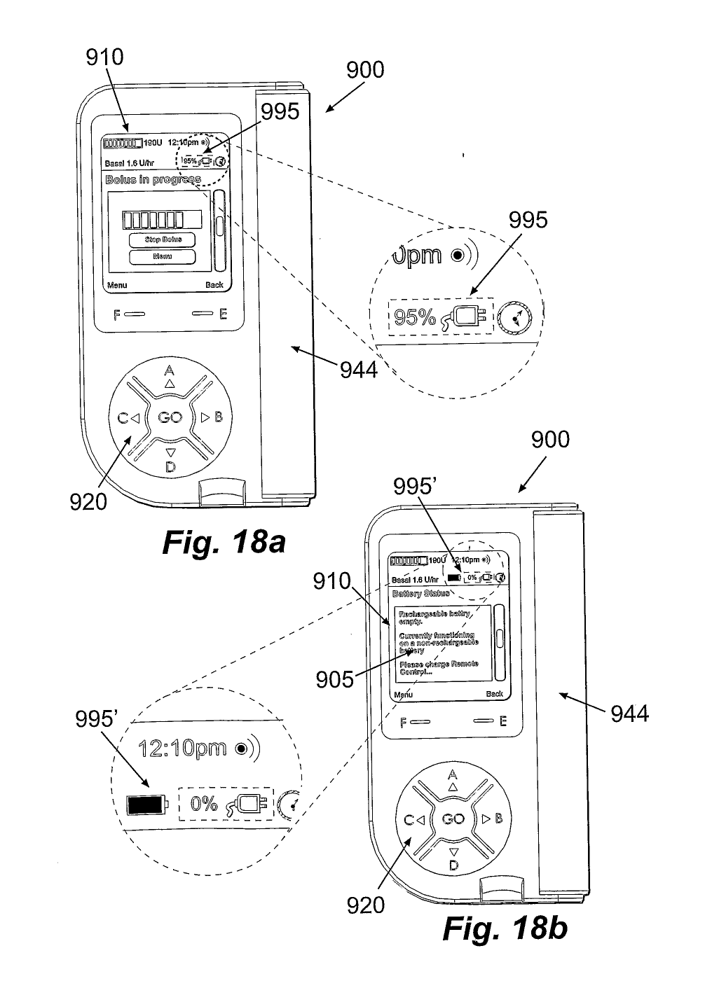

FIG. 18a illustrates the remote control 900 when the SOC of the rechargeable battery is 0.95, as displayed by a charge status indication 995. FIG. 18b illustrates the remote control when the rechargeable battery has depleted to SOC=0.05, as displayed by a charge status indication 995′. A notification 905 is provided on the display 910 when the remote control uses an auxiliary power source 944 instead of the rechargeable battery.

Various embodiments of the subject matter described herein may be realized in digital electronic circuitry, integrated circuitry, specially designed ASICs (application specific integrated circuits), computer hardware, firmware, software, and/or combinations thereof. These various embodiments may include embodiments in one or more computer programs that are executable and/or interpretable on a programmable system including at least one programmable processor, which may be special or general purpose, coupled to receive data and instructions from, and to transmit data and instructions to, a storage system, at least one input device, and at least one output device. In particular, some embodiments include specific “modules” which may be implemented as digital electronic circuitry, integrated circuitry, specially designed ASICs (application specific integrated circuits), computer hardware, firmware, software, and/or combinations thereof.

These computer programs (also known as programs, software, software applications or code) include machine instructions for a programmable processor, and may be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the subject matter described herein may be implemented on a computer having a display device (e.g., a CRT (cathode ray tube) or LCD (liquid crystal display) monitor) for displaying information to the user and a keyboard and a pointing device (e.g., a mouse or a trackball) by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

Some or all of the subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an embodiment of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other.

Any and all references to publications or other documents, including but not limited to, patents, patent applications, articles, webpages, books, etc., presented in the present application, are herein incorporated by reference in their entirety.

Although a few variations have been described in detail above, other modifications are possible. For example, the logic flow depicted in the accompanying figures and described herein do not require the particular order shown, or sequential order, to achieve desirable results.

Example embodiments of the methods, systems and components of the present disclosure have been described herein. As noted elsewhere, these example embodiments have been described for illustrative purposes only, and are not limiting. Other embodiments are possible and are covered by the disclosure. Such embodiments will be apparent based on the teachings contained herein. It is also understood that various modifications may be made without departing from the spirit and scope of the invention. Accordingly, other embodiments are within the scope of the following claims.

1.-23. (canceled)

24. A portable medical treatment and/or monitoring system comprising:
a medical device to perform at least one medical operation; and
a remote control to control, at least in part, operation of the medical device, the remote control comprising:
a rechargeable power source to power at least part of the remote control,
at least one connector to electrically couple the remote control to at least one other power source located externally to the remote control, and
a controller configured with instructions to cause the remote control to receive power from one or more of: the rechargeable power source and the at least one other power source.

25. A system as in claim 24, wherein the at least one other power source comprises one or more auxiliary non-rechargeable batteries.

26. A system as in claim 24, wherein the controller is configured with instructions to cause the remote control to receive power, based on at least one measured characteristic of the rechargeable source, from one or more of: the rechargeable power source and the at least one other power source.

27. A system as in claim 26, wherein the at least one measured characteristic includes at least one of: charge level of the rechargeable power source, voltage level of the rechargeable power source and temperature of the rechargeable power source.

28. A system as in claim 24, wherein the controller is configured with instructions to cause the remote control to receive power from the rechargeable power source when a determined charge level of the rechargeable source exceeds a pre-determined threshold representative of a charge level sufficient to continue power delivery from the rechargeable source for a predetermined period of time.

29. A system as in claim 25, wherein the controller is configured with instructions to cause the remote control to receive power from the one or more auxiliary non-rechargeable batteries electrically connected to the remote control when a determined charge level of the rechargeable source is below a pre-determined threshold representative of an insufficient charge level to continue power delivery from the rechargeable source for a predetermined period of time.

30. A system as in claim 24, wherein the rechargeable power source comprises one or more rechargeable batteries.

31. A system as in claim 24, wherein the at least one connector comprises at least one connector to electrically couple the remote control to an external high power source for providing power to cause one or more of: charge of the rechargeable power source and power at least part of the remote control.

32. A system as in claim 24, wherein the at least one connector comprises a USB connector.

33. A system as in claim 25, further comprising a chamber detachably connected to the remote control, the chamber configured to receive the one or more auxiliary non-rechargeable batteries, the one or more auxiliary non-rechargeable batteries being electrically coupled to the at least one connector.

34. A system as in claim 24, wherein the at least one connector is configured to electrically couple to a plurality of auxiliary power sources.

35. A system as in claim 24, wherein the at least one connector comprises a first connector to electrically couple to a first auxiliary power source and a second connector to electrically couple to a second auxiliary power source.

36. A system as in claim 24, wherein the remote control further comprises a casing to house the remote control, the casing further comprises:
a chamber to house the at least one other power source,
and
the at least one connector to electrically connect between the remote control and the at least one other power source.

37. A system as in claim 24, wherein the remote control further comprises notifying means to provide output information to a user regarding one or more of: charge level in the rechargeable power source, performance of a recharging operation of the rechargeable power source, electrical connectivity of power sources to the remote control and parameters related to one or more of the rechargeable power source and the at least one other power source.

38. A system as in claim 24, wherein the remote control further comprises one or more gauges to monitor the rechargeable power source and the at least one other power source.

39. A system as in claim 25, wherein the controller is configured to determine, based on at least one measured characteristic, a charge level of at least the rechargeable source and the one or more auxiliary non-rechargeable batteries.

40. A system as in claim 24, wherein the remote control further comprises a memory to store data related to the operation of the dispensing unit and at least one measured characteristic of the rechargeable source.

41. A system as in claim 24, wherein the medical device comprises one or more of: a therapeutic fluid dispensing device to deliver the therapeutic fluid to the body of a patient and a sensor to measure the patient's analytes concentration levels.

42. A system as in claim 24, wherein the remote control further comprises a sensor to measure a patient's analytes concentration levels.

43. A system as in claim 42, wherein the sensor comprises one or more of: a glucometer and a continuous glucose monitor (CGM).

44. A system as in claim 25, further comprising circuitry configured for providing electrical power to the remote control via the rechargeable power source or via the one or more auxiliary non-rechargeable batteries, interchangeably.

45. A system as in claim 31, wherein:
the at least one other power source comprises one or more auxiliary non-rechargeable batteries, and
the system further comprises circuitry configured to disconnect the one or more auxiliary non-rechargeable batteries when the external high power source is electrically connected to the remote control.

46. A system for dispensing therapeutic fluid to a body of a patient and/or sensing a body analyte of the patient, the system comprising:
a medical device to perform at least one medical operation, wherein the medical device includes a pump and/or a sensor and wherein the medical operation includes at least one of dispensing the therapeutic fluid to the body of the patient and a sensor for sensing a concentration level of a body analyte of the patient; and
a remote control which controls, at least in part, operation of the medical device, the remote control comprising:
a rechargeable power source which powers at least part of the remote control,
at least one connector which electrically couples the remote control to one or more auxiliary non-rechargeable batteries located externally to the remote control,
and
a controller which directs power to the remote control from either the rechargeable power source or the one or more auxiliary non-rechargeable batteries.
